(19) United States
(12) Patent Application Publication
(10) Pub. No.: US 2006/0103635 A1
(43) Pub. Date: May 18, 2006

(54) Device and method of avoiding noise in touch screen panel

(75) Inventor: Jun-youb Park, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/274,237

(22) Filed: Nov. 16, 2005

(30) Foreign Application Priority Data
Nov. 17, 2004 (KR) 10-2004-0094266

(51) Int. Cl. G09G 5/00

(52) U.S. Cl. 345/173

(57) ABSTRACT

A method of avoiding noise in a touch screen panel, and a device to perform the method, the method including providing a clock signal to a control unit to control the touch screen panel; wherein the clock signal is supplied to the control unit according to a received touch screen input signal and a noise related signal.

### CROSS-REFERENCE TO RELATED APPLICATIONS

This application claims the benefit of Korean Patent Application No. 10-2004-0094266, filed on Nov. 17, 2004, in the Korean Intellectual Property Office, the disclosure of which is incorporated herein by reference.

### BACKGROUND OF THE INVENTION

1. Field of the Invention

The present invention relates to a touch screen panel, and, more particularly, to a device and method of avoiding noise in a touch screen panel.

2. Description of the Related Art

Touch screen systems have become a popular mode of user interface, and are used in many types of applications, such as an input device of a portable terminal. Since a touch screen is affixed to a display screen, a user can intuitively connect a pressure point of the touch screen with a corresponding point of the display screen (this is referred to as “institution”), and an active connection with a screen can be created.

To implement a touch screen as the input device, accurate coordinate data of a user's touch point must be obtained. However, the touch screen is a linear analog device, and is very close to a display device, and, therefore, the touch screen is largely affected by noise. The noise may include a noise component included in a signal of the display device, or a noise component generated by a power source unit. Such noise is transferred to the analog coordinate data which is input to a controller of a touch screen panel (TSP), and causes errors in the coordinate values.

To correct the errors, methods such as comparing sampled values of inputs or interrupting the operation of a display are used. However, such methods use complex comparison operations, and, therefore, degrade system performance, and cannot be adopted in a case in which an input clock signal of a display cannot be controlled.

In particular, since the system performance of a mobile terminal such as a personal digital assistant (PDA) is generally inferior to that of a personal computer, if a large amount of time and complex operations are used to process data of the touch screen which is frequently used, the system performance deteriorates and the battery life is reduced.

### SUMMARY OF THE INVENTION

The present invention provides a method of avoiding noise from a display device in a touch screen panel without degrading system performance, a device to perform the method, and a computer readable recording medium having embodied thereon a computer program to execute the method of avoiding noise.

The present invention also provides a method of controlling a touch screen panel, a device to perform the method, and a computer readable recording medium having embodied thereon a computer program to execute the method of controlling the touch screen panel.

Additional aspects and/or advantages of the invention will be set forth in part in the description which follows and, in part, will be apparent from the description, or may be learned by practice of the invention.

According to an aspect of the present invention, there is provided a device to avoid noise of a touch screen panel, the device comprising: a user input receiving unit to receive a touch screen input of a user; a noise reduction signal generating unit to generate a noise reduction signal which indicates a point at which noise is reduced in a display using a noise related signal from the display; and a clock controlling unit to control an external clock signal to be provided or not provided to a touch screen control device in response to the touch screen input of a user and the noise reduction signal.

According to another aspect of the present invention, there is provided a method of avoiding noise of a touch screen panel, the method comprising: determining whether a touch screen input of a user is received; stopping provision of an external clock to a control device of the touch screen panel in response to receiving the touch screen input; determining whether noise is reduced according to a noise related signal from a display; and resuming provision of the external clock in response to the noise being reduced.

According to another aspect of the present invention, there is provided a control device of a touch screen panel, the control device comprising: a user input receiving unit to receive a touch screen input of a user; a noise reduction signal generating unit to generate a noise reduction signal which indicates a point at which noise is reduced in a display using a noise related signal from the display; and a signal controlling unit which stops or resumes controlling a signal of the touch screen in response to the touch screen input of the user and the noise reduction signal.

According to another aspect of the present invention, there is provided a method of controlling a touch screen panel, the method comprising: determining whether a touch screen input is received from a user; stopping a control operation of the touch screen in response to receiving the touch screen input; determining whether noise is reduced in a display according to a noise related signal from the display; and resuming the control operation of the touch screen in response to the noise being reduced.

According to another aspect of the present invention, there is provided an apparatus having a touch screen panel, the apparatus comprising: a control unit to control the touch screen panel according to a received clock signal; and a clock controlling unit to supply the clock signal to the control unit according to a received touch screen input signal and a noise related signal.

According to another aspect of the present invention, there is provided a method of controlling a touch screen panel, the method comprising: providing a clock signal to a control unit to control the touch screen panel; wherein the clock signal is supplied to the control unit according to a received touch screen input signal and a noise related signal.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a configuration diagram illustrating a touch screen input device;

FIG. 2A is a conceptual diagram illustrating the operation in a case in which x-coordinate data of a user input is read in a touch screen input device;

FIG. 2B is a conceptual diagram illustrating the operation in a case in which y-coordinate data of a user input is read in a touch screen input device;

FIG. 3 is a graph illustrating an input signal and an output signal in the case in which the x-coordinate data of the user is input in the touch screen input device;

FIG. 4 illustrates a schematic configuration diagram of an LCD (liquid crystal display) display device;

FIG. 5 is a diagram illustrating a noise related signal of an LCD display;

FIG. 6 is an enlarged diagram of part of FIG. 5 in which noise is generated;

FIG. 7 is a block diagram illustrating the configuration of a noise reduction avoiding device of a TSP (touch screen panel) according to an embodiment of the present invention;

FIG. 8 is a flowchart illustrating a noise avoiding method of a TSP according to an embodiment of the present invention;

FIG. 9 illustrates a timing diagram of signals related to the method of avoiding noise of the TSP;

FIG. 10 is a block diagram illustrating the configuration of a TSP control device according to another embodiment of the present invention; and

FIG. 11 is a flowchart illustrating a TSP control method according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

In general, a touch screen is an interface device between an information communications device employing various displays and a user, and allows the user to input data to the device by directly touching a screen with an object such as a finger or a pen, without a peripheral device such as a keyboard or a mouse. The touch screen can be one of various types, such as electrostatic, resistance film, ultrasonic wave, electric field, and infrared ray types.

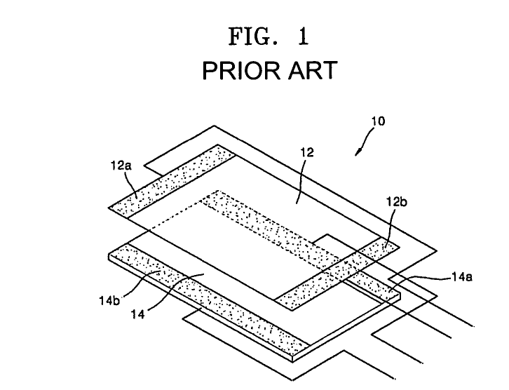

The configuration of a touch screen in a resistance film type is shown in FIG. 1. FIG. 1 is a schematic diagram illustrating the configuration of a touch screen panel 10. The touch screen panel 10 in a resistance film type includes an upper board 12 and a lower board 14, which are transparent conductive films. Electrodes 12a and 12b are formed at both sides of the upper board 12. Electrodes 14a and 14b are formed at the top and bottom of the lower board 14. When the conductive film of the upper board 12 contacts the conductive film of the lower board 14 due to external pressure, the resistances measured on the top, bottom, left, and right sides are different according to the touch point, and, therefore, the contact position can be detected by interpreting the different resistances. That is, after constant voltages are applied between both sides of the upper board 12 and lower board 14, respectively, voltages changed by the resistances are measured and analog coordinate data is obtained. Then, analog-digital conversion (ADC) is performed on the obtained coordinate data, and digital coordinate data is acquired.

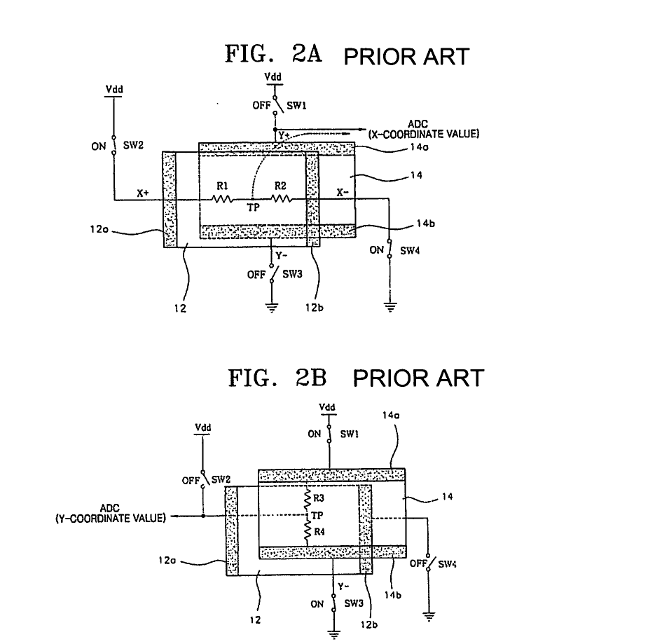

FIGS. 2A and 2B are conceptual diagrams respectively illustrating the operations in a case in which an x-coordinate and a y-coordinate of a user input on a touch screen are measured.

Referring to FIG. 2A, a voltage is applied to both electrodes 12a and 12b of the upper board 12 to detect the x-coordinate of the user input. In this state, if one point of a touch screen panel is pressed and the upper board 12 touches the lower board 14, the voltage at that point, i.e., touch point TP, is applied to both electrodes of the lower board 14. For example, as shown in FIG. 2A, if Vdd is applied between the left electrode 12a and the right electrode 12b, the resistance between the left electrode 12a and the touch point TP is R1, and the resistance between the right electrode 12b and the touch point TP is R2, and the voltage at the touch point TP becomes VTP=R2/(R1+R2)*Vdd.

Referring to FIG. 2B, a voltage is applied to both electrodes 14a and 14b of the lower board 14 to detect the y-coordinate of the user input. In this state, if one point of the touch screen panel is pressed and the upper board 12 touches the lower board 14, the voltage at the touch point TP becomes VTP=R4/(R3+R4)*Vdd.

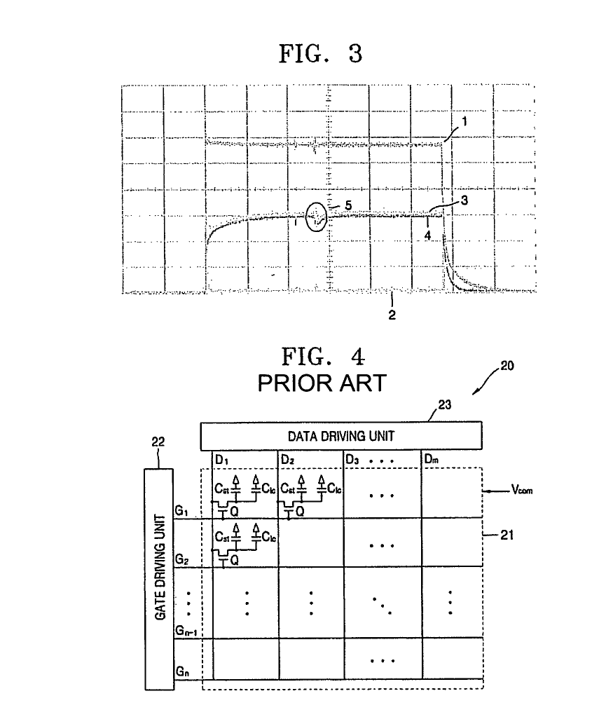

FIG. 3 is a graph illustrating voltages measured on each electrode shown in FIG. 2A. As shown in FIG. 3, after input voltages 1 and 2 are applied to the left electrode 12a and the right electrode 12b, respectively, output voltages 3 and 4 of the top electrode 14a and the bottom electrode 14b are respectively measured.

Referring to FIG. 3, severe distortion is observed in the middle of each output voltage 3 and 4, as denoted by reference number 5. This distortion is caused by noise from a display device. Accordingly, when there is noise, the output voltage is changed. Therefore, a method of avoiding the noise is required.

As an example of a display device, a liquid crystal display (LCD) will be examined to determine the cause of noise.

FIG. 4 is a diagram illustrating the schematic configuration of an LCD panel 20.

Referring to FIG. 4, the LCD panel 20 includes a liquid crystal panel assembly 21, a gate driving unit 22, and a data driving unit 23.

The liquid crystal panel assembly 21 is connected to a plurality of display signal lines G1 through Gn and D1 through Dm, and displays a plurality of pixels which are arranged in a matrix. The display signal lines G1 through Gn and D1 through Dm include a plurality of gate lines G1 through Gn, which transmit gate signals, and a plurality of data lines D1 through Dm, which transmit data signals.

The gate driving unit 22 is connected to the gate lines G1 through Gn of the liquid crystal panel assembly 21, and applies an external gate signal to each gate line. The gate driving unit 22 includes a plurality of gate ICs (not shown), each of which corresponds to a gate line.

The data driving unit 23 is connected to the data lines D1 through Dm of the of the liquid crystal panel assembly 21, and applies data signals corresponding to each pixel to the respective data lines. The data driving unit 23 includes a plurality of data ICs (not shown), each of which corresponds to a data line.

In a horizontally driven LCD panel, each gate IC is sequentially turned on and off, and simultaneously applies a gate signal to a row. At the same time, the data ICs apply data signals corresponding to the pixels of the row. The gate signals are changed more rapidly than the data signals, to perform turn-on/off operations, and thus, a large amount of noise is generated at the instance of the turning-on/off operations.

The generation of noise according to the change of the gate signals will now be described with reference to FIG. 5.

FIG. 5 is a diagram illustrating noise related signals of the LCD panel 20. In FIG. 5, two gate ICs repeatedly and alternately generate on and off signals as the noise related signals. Also, signals 25 and 26 of each gate IC, and a signal 27 indicating the points at which noise is generated, are shown in FIG. 5.

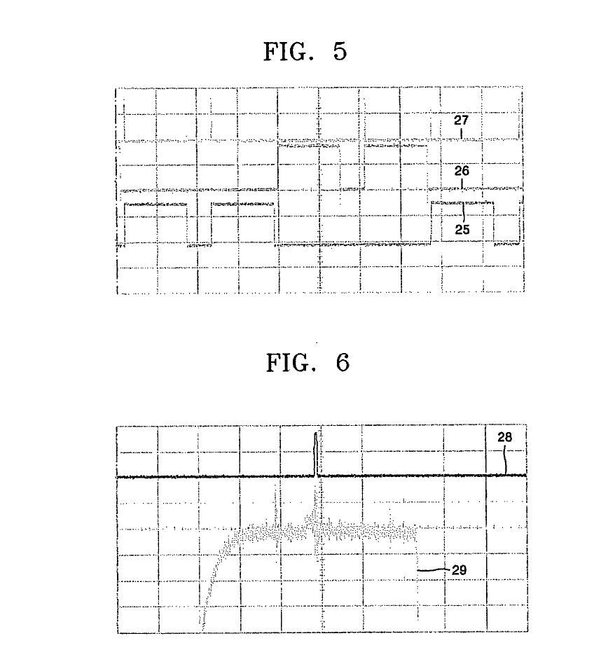

Referring to FIG. 5, at the point at which each of the gate IC signals 25 and 26 turns on, a large amount of noise is generated. One of the points is shown in FIG. 6 in more detail.

FIG. 6 illustrates an enlarged view of part of FIG. 5 in which the noise is generated. To more clearly show the part where the noise is generated, the gate IC signal 29, including noise, is enlarged more than the signal 28 indicating that the noise occurs.

Since a large amount of noise is generated due to the gate IC signal in the LCD panel, the coordinates of the user input on the touch screen panel may be incorrect. Therefore, methods of avoiding such errors are required. Conventionally, the coordinates of the user input are measured several times (e.g., more than three times) in a TSP (touch screen panel) controller. Values of the coordinates within an error range are acquired, and values of the coordinates outside the error range are discarded. However, such a method is performed using software, and thereby serious degradation can occur in a mobile terminal having lower CPU performance.

Further, in such a conventional method, a large amount of the sampled coordinate data is identified as outside the error range, and is accordingly discarded. Therefore, in cases such as which a user inputs quickly or performs a drawing operation continuously, the processing speed cannot keep up with the user input speed.

To resolve this problem, a method of controlling a clock signal provided to an LCD panel has been employed. This method prevents noise from being generated on an LCD panel by stopping the clock signal provided to the LCD panel while a TSP controller reads coordinate values of a user input. However, this method is not applicable in a case in which an LCD controller is unable to control an input clock signal. In other words, this method can only be used with a specific LCD controller which supports the method.

Therefore, in the present invention, a method of avoiding noise generated in a display controlling unit is provided such that TSP coordinate data which is transmitted from a TSP controller to a central processing unit has a high reliability without additional burden on system performance.

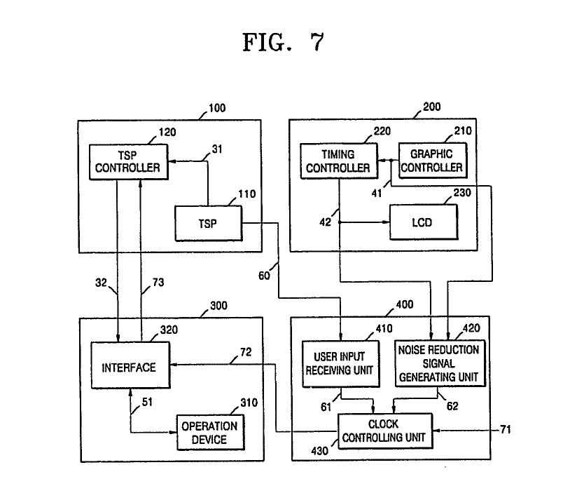

FIG. 7 is a block diagram illustrating the configuration of a TSP noise avoiding device 400 according to an embodiment of the present invention. For convenience of description, a touch screen panel device 100, a display device 200, and a central processing unit 300 are also illustrated.

Referring to FIG. 7, the TSP noise avoiding device 400 includes a user input receiving unit 410, a noise reduction signal generating unit 420, and a clock controlling unit 430.

The user input receiving unit 410 receives a touch screen input signal 60 from a user. The touch screen panel device 100 includes a touch screen panel 110 and a TSP controller 120 which controls the touch screen panel 110. When a user touches the touch screen panel with an object such as a finger or a pen, the touch screen input signal 60 is generated and transmitted to the user input receiving unit 410. The user input receiving unit 410 transmits a touch screen input signal 61 to the clock controlling unit 430.

The noise reduction signal generating unit 420 receives noise related signals 41 and 42 from the display device 200, and generates a noise reduction signal 62 which indicates the point at which the noise is reduced in the display device 200 using the received noise related signals 41 and 42. The LCD display panel device 200 includes a liquid crystal panel 230, a timing controller 220 to control the liquid crystal panel 230, and a graphic controller 210 which generates a graphic signal to be displayed on a screen. As previously described above, signals 41 and 42, generated in the graphic controller 210 and the timing controller 220, respectively, result in a large amount of noise.

The clock controlling unit 430 receives a signal from an external clock 71 and supplies or interrupts a TSP supply clock 72 to the TSP controller 120 in response to receiving the touch screen input signal 61 and the noise reduction signal 62.

In the present embodiment illustrated in FIG. 7, the TSP controller 120 has an interface capable of using an external signal, and is provided with an external signal 73 through an interface 320 of the central processing unit 300. However, in another embodiment, the external clock may be directly provided from the clock controlling unit 430 to the TSP controller 120.

When a user's touch screen input signal 61 is received, the clock controlling unit 430 stops supplying the TSP supply clock 72, and according to the receipt of a noise reduction signal 62, which indicates the point at which the noise is reduced, from the noise reduction signal generating unit 420, the clock controlling unit 430 resumes providing the TSP supply clock 72. The clock controlling unit 430 may resume providing the TSP supply clock 72 in response to receiving the noise reduction signal 62, or in response to the termination of the received noise reduction signal 62, or other similar method in which the provision of the TSP supply clock 72 is made according to the receipt of the noise reduction signal 62.

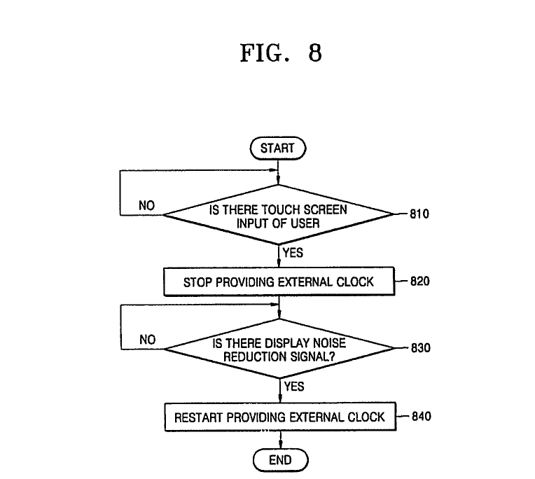

FIG. 8 is a flowchart illustrating a TSP noise avoiding method according to an embodiment of the present invention.

Referring to FIG. 8, the user input receiving unit 410 determines whether the touch screen input signal 60 from a user has been received (operation 810). The user input receiving unit 410 repeats the checking operation until the touch screen input signal 60 is received, and then transmits the touch screen input signal 61 to the clock controlling unit 430.

When the touch screen input signal 61 has been received, the clock controlling unit 430 stops supplying the TSP supply clock 72 to the TSP controller 120 (operation 820).

The noise reduction signal generating unit 420 receives the noise related signals 41 and 42 from the display device 200, and generates the noise reduction signal indicating the point at which the noise is reduced on the display by using the received noise related signals 41 and 42. The clock controlling unit 430 determines whether the noise reduction signal has been received (operation 830), and resumes supplying the TSP supply clock 72 to the TSP controller 120 according to the noise reduction signal 62 (operation 840).

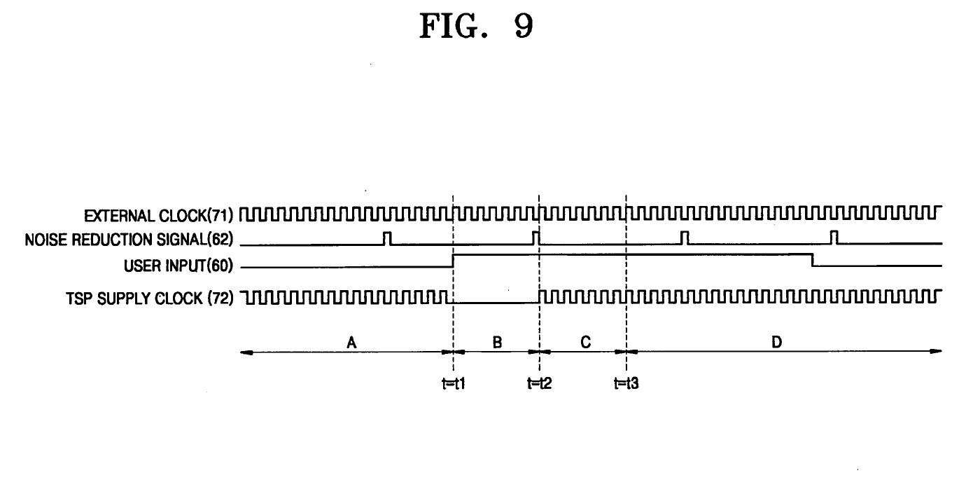

The noise reduction signal 62 indicates the point at which the noise is reduced on the display, and is generated using the noise related signals 41 and 42 transmitted from the display device 200. As previously described above, the gate IC signals 25 and 26 of the LCD panel 20 are primary sources of noise. Accordingly, at points at which the gate IC signals 25 and 26 are rapidly altered, a signal 27 indicating noise occurrence is generated. In the present embodiment, the signal 27 is used as a noise generating reduction signal. Such operation will be described with reference to FIG. 9.

FIG. 9 illustrates a timing diagram of signals related to the TSP noise avoiding method. In the embodiment of FIG. 9, the noise generating signal 27 is used as the noise reduction signal 62. The noise reduction signal 62 is turned on, and has a value of ‘1’, at the points at which the gate IC signals 25 and 26 are rapidly altered. Thus, when the noise reduction signal 62 is turned off, and has a value of ‘0’, the gate IC signals 25 and 26 are constant.

During a period A in which there is no user input, the signal from the external clock 71 is provided to the TSP, and the provided signal from the external clock 71 is referred to the TSP supply clock 72. When there is a user input, the user input signal 60 is generated at a point t=t1, and the TSP supply clock 72 is not provided to the TSP during a period B. The noise reduction signal 62, which has a value of ‘1’ during a period in which the gate IC signal is rapidly altered, has a value of ‘0’ during a period that the gate IC signal is constant. Therefore, in the present embodiment illustrated in FIG. 9, the TSP supply clock 72 is re-supplied to the TSP at the point t=t2 at which the noise reduction signal 62 changes to ‘0’.

In FIG. 9, during a period C, since it is assured that no noise is generated, coordinate data of the user input is sampled.

In an experiment in which a noise reduction signal was generated using only the gate IC signals 25 and 26 of the LCD device 20, after the noise avoiding method according to the present invention was applied to the experiment, the available sample ratio increased from 8 percent to 94 percent.

The noise avoiding method and device according to the present invention can be easily implemented using a complex programmable logic device (CPLD) or an equivalent logic circuit. Particularly, a wireless device such as a PDA is equipped with a CPLD, and therefore, additional hardware is not required.

In another embodiment of the present invention, the noise reduction device and method can be implemented to be integrated with the timing controller 220 of the display device 200 because, in general, the timing controller 220 is also implemented using a CPLD.

In another embodiment of the present invention, the noise reduction device and method can be implemented to be integrated with the TSP controller 120 of the touch screen panel device 100. In this case, the TSP control operation can be directly controlled without additionally controlling an external clock signal.

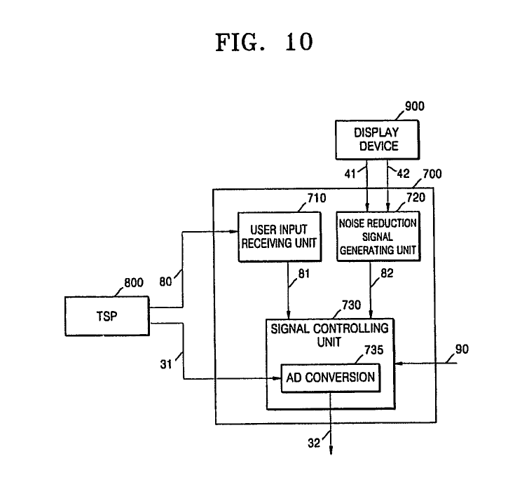

FIG. 10 is a block diagram illustrating a TSP controlling unit using the noise avoiding method according to an embodiment of the present invention. Referring to FIG. 10, the TSP controlling unit 700 may include a user input receiving unit 710, a noise reduction signal generating unit 720, and a signal controlling unit 730.

The user input receiving unit 710 receives a user input 80 from a touch screen panel 800. When there is a user input 80, the user input receiving unit 710 transmits the user input 80 to the signal controlling unit 730. The transmitted user input is denoted by reference number 81.

The noise reduction generating unit 720 receives noise related signals 41 and 42 from a display device 900, and generates a noise reduction signal 82 indicating the point at which noise is reduced.

The signal controlling unit 730 stops or restarts controlling signals of the touch screen in response to the touch screen input 81 of the user and the noise reduction signal 82. The signal controlling unit 730 receives a signal from an external clock 90. When the touch screen input 81 is transmitted from the user input receiving unit 710, the signal controlling unit 730 stops controlling the signal of the touch screen, and resumes controlling the signal of the touch screen according to receipt of the noise reduction signal 82.

The signal controlling unit 730 may include an analog-digital converter (ADC) 735 to convert analog coordinate data 31 generated in the touch screen to digital coordinate data 32. In the present embodiment, when the touch screen input 81 is transmitted from the user input receiving unit 710, the analog-digital conversion is stopped, and restarted upon receiving the noise reduction signal 82.

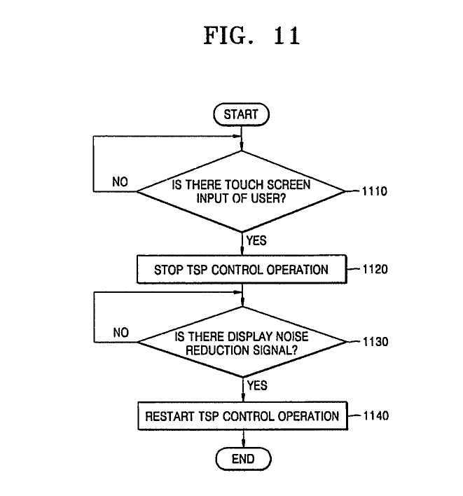

FIG. 11 is a flowchart illustrating a TSP control method according to an embodiment of the present invention.

First, the user input receiving unit 710 determines whether there is a touch screen input from the user (operation 1110). The user input receiving unit 710 repeats the checking operation until the touch screen input 80 from the user is detected, and then transmits the touch screen input 81 to the signal controlling unit 730.

When the touch screen input 81 is received, the signal controlling unit 730 stops a controlling operation of a touch screen panel 800 (operation 1120). Then, the signal controlling unit 730 determines whether the display noise reduction signal 82 has been received (operation 1130).

The noise reduction signal generating unit 720 receives the noise related signals 41 and 42 and generates a noise reduction signal 82 indicating the point at which the noise is reduced, using the received noise related signals 41 and 42. Upon receiving the noise reduction signal 82, the signal controlling unit 730 resumes the controlling operation of the touch screen panel 800 (operation 1140).

The invention may also be embodied as computer readable code on a computer readable recording medium. A computer includes all devices having an information processing function. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices.

According to a method, and a device using the method, of avoiding noise in a touch screen panel according to the present invention, an external clock signal is not supplied to a touch screen panel during the period in which noise is generated, and coordinate data is sampled in a portion where the noise is reduced. Therefore, the sampled data has high reliability. Also, the method and device can be easily implemented without any additional devices, and can prevent degradation of system performance due to frequent user input. Further, by using the method and device according to the present invention, the battery life of a mobile terminal can be prolonged.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A device to avoid noise of a touch screen panel, the device comprising:
a user input receiving unit to receive a touch screen input of a user;
a noise reduction signal generating unit to generate a noise reduction signal which indicates a point at which noise is reduced in a display using a noise related signal from the display; and
a clock controlling unit to control an external clock signal to be provided or not provided to a touch screen control device in response to the touch screen input of a user and the noise reduction signal.

2. The device of claim 1, wherein the clock controlling unit comprises:
a unit to stop providing the external clock signal to the touch screen control device in response to receiving the touch screen input from the user; and
a unit to resume providing the external clock signal in response to receiving the noise reduction signal.

3. The device of claim 1, wherein the display is an LCD (liquid crystal display).

4. The device of claim 3, wherein the noise related signal is generated according to a control of a gate IC of the LCD display.

5. The device of claim 1, wherein the touch screen control device comprises a unit to convert analog coordinate data of the touch screen to digital coordinate data.

6. A method of avoiding noise of a touch screen panel, the method comprising:
determining whether a touch screen input of a user is received;
stopping provision of an external clock to a control device of the touch screen panel in response to receiving the touch screen input;
determining whether noise is reduced according to a noise related signal from a display; and
resuming provision of the external clock in response to the noise being reduced.

7. The method of claim 6, wherein the display is an LCD (liquid crystal display).

8. The method of claim 7, wherein the noise related signal is generated according to a control of a gate IC of the LCD display.

9. The method of claim 6, wherein the control device of the touch screen panel comprises a unit to convert analog coordinate data of the touch screen to digital coordinate data.

10. A control device of a touch screen panel, the control device comprising:
a user input receiving unit to receive a touch screen input of a user;
a noise reduction signal generating unit to generate a noise reduction signal which indicates a point at which noise is reduced in a display using a noise related signal from the display; and
a signal controlling unit which stops or resumes controlling a signal of the touch screen in response to the touch screen input of the user and the noise reduction signal.

11. The control device of claim 10, wherein the signal controlling unit comprises:
a unit to stop controlling the signal of the touch screen in response to receiving the touch screen input from the user; and
a unit to resume controlling the signal of the touch screen in response to receiving the noise reduction signal.

12. The control device of the claim 10, wherein the signal controlling unit comprises an analog-digital (AD) converter to convert analog coordinate data of the touch screen to digital coordinate data.

13. The control device of claim 10, wherein the display is an LCD (liquid crystal display).

14. The control device of claim 13, wherein the noise related signal is generated according to a control of a gate IC of the LCD display.

15. A method of controlling a touch screen panel, the method comprising:
determining whether a touch screen input is received from a user;
stopping a control operation of the touch screen in response to receiving the touch screen input;
determining whether noise is reduced in a display according to a noise related signal from the display; and
resuming the control operation of the touch screen in response to the noise being reduced.

16. The method of claim 15, wherein the display is an LCD (liquid crystal display).

17. The method of claim 16, wherein the noise related signal is generated according to a control of a gate IC of the LCD display.

18. The method of claim 15, wherein the control operation of the touch screen comprises converting analog coordinate data of the touch screen to digital coordinate data.

19. A computer readable recording medium having embodied thereon a computer program to cause a computer to execute the operations of:
determining whether a touch screen input of a user is received;
stopping provision of an external clock signal to a control device of the touch screen in response to receiving the touch screen input;
determining whether noise is reduced in a display according to a noise related signal from the display; and
resuming provision of the external clock signal in response to the noise being reduced.

20. A computer readable recording medium having embodied thereon a computer program to cause a computer to execute the operations of:
determining whether a touch screen input is received from a user;
stopping a control operation of the touch screen in response to receiving the touch screen input;
determining whether noise is reduced in a display according to a noise related signal from the display; and
resuming the control operation of the touch screen in response to the noise being reduced.

21. An apparatus having a touch screen panel, the apparatus comprising:
a control unit to control the touch screen panel according to a received clock signal; and
a clock controlling unit to supply the clock signal to the control unit according to a received touch screen input signal and a noise related signal.

22. The apparatus of claim 21, wherein the display is an LCD (liquid crystal display).

23. The apparatus of claim 22, wherein the noise related signal is generated according to a control of a gate IC of the LCD display.

24. The apparatus of claim 21, wherein the clock controlling unit suspends the clock signal according to the received touch screen input signal, and resumes supply of the clock signal according to the received noise related signal.

25. A method of controlling a touch screen panel, the method comprising:
providing a clock signal to a control unit to control the touch screen panel;
wherein the clock signal is supplied to the control unit according to a received touch screen input signal and a noise related signal.

26. The method of claim 25, wherein the display is an LCD (liquid crystal display).

27. The method of claim 26, wherein the noise related signal is generated according to a control of a gate IC of the LCD display.

28. The method of claim 25, wherein the clock signal is suspended according to the received touch screen input signal, and resumed according to the received noise related signal.
